(19) United States
(12) Patent Application Publication
(10) Pub. No.: US 2022/0325915 A1
(43) Pub. Date: Oct. 13, 2022

(54) DUCT CLAMP ASSEMBLY

(71) Applicant: CECO ENVIRONMENTAL IP INC., Dallas, TX (US)

(72) Inventors: Jason MOTE, Dallas, TX (US); Thomas FROSELL, Dallas, TX (US)

(21) Appl. No.: 17/229,538

(22) Filed: Apr. 13, 2021

(51) Int. Cl. F24F 13/02; F16L 23/06; F16L 23/00

(52) U.S. Cl. CPC F24F 13/0209; F16L 23/06; F16L 23/003

(57) ABSTRACT

A duct clamp assembly comprises a clamp configured to apply pressure around a connection point of two duct segments, and a gasket positioned on an inner surface of the clamp. The gasket comprises a body made of a foam and a layer made of a solid polymer, and the layer extends around an outer surface of the body.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present disclosure relates to a duct clamp assembly for connecting segments of ducting together.

### BACKGROUND

Ducts are used in various applications for the flow of gas(es) therethrough, typically in the context of circulated gases or exhaust gases. For example, ducts are used in heating, ventilation, and air conditions (HVAC) systems to circulate air between a heating/cooling unit and rooms in a building. Heated or cooled air is delivered to rooms in the building and room air is returned to the heating/cooling unit. In another example, ducts are used in various industrial applications in order to remove exhaust gases from the process environment, often to channel the gases to environmental treatment units.

### SUMMARY

In some embodiments, a duct clamp assembly comprises a clamp configured to apply pressure around a connection point of two duct segments, and a gasket positioned on an inner surface of the clamp. The gasket comprises a body made of a foam and a layer made of a solid polymer, and the layer extends around an outer surface of the body.

In some embodiments, a method for clamping two segments of duct together comprises placing a duct clamp assembly around a connection point of the two segments of duct, and compressing a gasket of the duct clamp assembly against the connection point. The gasket comprises a body made of a foam and a layer made of a solid polymer, and the layer extends around an outer surface of the body.

In some embodiments, a method for maintaining a connection point of two segments of duct held together by a duct clamp assembly comprising a clamp and a gasket compressed between the clamp and the connection point comprises pivoting a locking member of a latch of the clamp out of a bridge member of the latch and then out of a slot of the latch, and removing a compression force from the gasket. The gasket comprises a body made of a foam and a layer made of a solid polymer, and the layer extends around an outer surface of the body.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIGS. 1A and 1B each illustrate a side view of two segments of duct that can be joined by the disclosed duct clamp assembly.

FIG. 2 illustrates a side view of an embodiment of the disclosed duct clamp assembly.

FIG. 3 illustrates a cross-section view of the ring-shaped member of the clamp and the gasket, taken along sight line 1-1 of FIG. 2.

FIG. 4A shows a cross-sectional view of the body of the gasket.

FIG. 4B shows a cross-sectional view of the gasket having the layer around the body.

FIGS. 5A and 5B each illustrate a side view of another embodiment of the disclosed duct clamp assembly. FIG. 5A shows the latch in the closed position, and FIG. 5B shows the latch in the open position.

FIG. 6 illustrates a close-up perspective view of the latch in FIGS. 5A and 5B.

FIG. 7 illustrates a close-up perspective view of the first end of the ring-shaped member placed over the second end of the ring-shaped member.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Typical ducting can be coupled using a clamp to retain the ends of two adjacent duct sections together. A gasket could be optionally used in some instances to prevent the leakage of gas from the duct at the joint. The clamp itself can generally have a handle that allows the clamp to move between an open configuration in which the diameter of the clamp is larger than when the clamp is in a closed configuration about the joint. A spring can be used to retain the handle in the closed position after the clamp is installed.

The term “foam” as used herein can refer to a matrix structure of a polymeric material, such as a natural or synthetic rubber, which has space occupied by a gas such as air. The structure of a “foam” can be described as expanded polymer, cellular, or a sponge. A “foam” as described herein can be formed by any technique known in the art with the aid of this disclosure.

The term “solid polymer” as used herein can refer to a polymeric material such as a natural or synthetic rubber. The term “solid polymer” is used herein to contrast with the structure of the foam, denoting a structure than is not a gas-containing matrix. Use of “solid” is not intended to limit the rigidity, hardness, or softness of the solid polymer. A “solid polymer” as described herein can be formed by any technique known in the art with the aid of this disclosure.

A continuous length of duct can be formed by connecting individual segments of the duct together. While various options are available, duct segments can be joined using a clamp. In applications in which a sealed connection is required, a gasket can be used between the clamp of the outer surface of the duct. The gasket functions to occupy any spaces between the clamp and the duct so as to prevent gases from leaking out of the duct at the connecting point.

In industrial applications, the gaskets for the clamps currently available on the market are easily damaged and are of single use. That is, the gasket can be damaged during installation, leading to inadequate seal of the duct clamp. Even when the gasket is not damages, the material can degrade over time or lack resiliency, making the gasket a onetime seal. Any removal of the clamp may not result in the gasket returning to its original shape. This can affect the duct during use as any movement of the duct may not result in the gasket conforming to the new shape of the duct, which can result in leakage. In many cases, spare gaskets are required for installation and maintenance of duct clamps due to the premature gasket mortality rate for clamp gaskets.

The clamp itself may also be inadequate in certain situations. For example, a simple clamp may be used to provide pressure to the joint between two ducting sections. The clamp may not be adequately sized to provide a sufficient sealing force on the sections to provide a seal. The use of various structures such as a compression bar versus a simple spring may provide a better seal for the duct. Further, some clamps may come unlatched during use or not retain the latching force even if not becoming fully unlatched. As disclosed herein, a lock or retaining mechanism can be used to retain the clamp in the closed and latched position. While some retaining mechanisms such as pin can be used, the pin can be lost or fall out over time. An integrated latch as disclosed herein can be used to retain the clamp in the latched or closed position without the risk of reopening or loss of the retaining mechanism.

Disclosed herein are a clamp designed to improve the overall clamping of two segments of ducting and a gasket design intended to improve the sealing of the duct segments. The duct clamp assembly disclosed herein is generally designed for joining together two segments of duct. The duct clamp assembly generally includes a clamp and a gasket as described herein. The gasket can have a body made of foam that is surrounded by a layer of solid polymer. It has been found that, by providing a solid polymer layer, or skin, around a foam body of the gasket, the disclosed duct clamp assembly can be applied to and removed from the connection point of two duct segments multiple times using the same gasket. The metal parts of duct clamps tend to cut into, shear, or otherwise compromise the integrity of gaskets after a single use, and another gasket is needed in many cases in order to reapply the clamps. The layer, or skin, that is included on the disclosed gasket allows the same gasket to be re-used, as well as to maintain an effective seal at the connection point of two duct segments. Additionally, the construction of some embodiments of the clamp disclosed herein provides for a stronger clamp assembly that can provide more uniform and consistent pressure or force to the connection point of two duct segments.

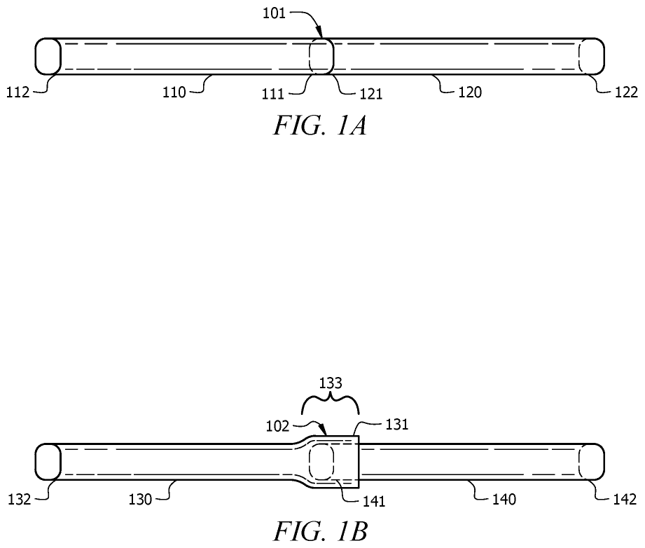

FIGS. 1A and 1B each illustrate a side view of two segments of duct that can be joined by the disclosed duct clamp assembly. The configurations in FIGS. 1A and 1B are not intended to limit the configuration of the connection point where the duct clamp assembly is placed.

FIG. 1A shows two duct segments 110 and 120. The first duct segment 110 has end 111 and opposite end 112, and the second duct segment 120 has end 121 and opposite end 122. In FIG. 1A, the end 111 of the first duct segment 110 faces the second end 121 of the second duct segment 120. The connection point 101 is the perimeter of duct where the end 111 of the first duct segment 110 and the end 121 of the second duct segment 120 meet. In some aspects, the ends 111 and 121 can have a shoulder or flare, and the two flared ends can be abutted together for purposes of clamping. The two flared ends can then form a lip around which the clamp, and optionally the gasket, can be placed to retain the ends 111 and 121 together during use. In some aspects, the disclosed duct clamp assembly is configured to be placed around the connection point 101 and to apply pressure around the connection point 101.

FIG. 1B shows two duct segments 130 and 140. The first duct segment 130 has end 131 and opposite end 132, and the second duct segment 140 has end 141 and opposite end 142. In FIG. 1B, the end 141 of the second duct segment 140 is placed within the end 131 of the first duct segment 130. That is, the end 131 of the first duct segment 130 has a portion 133 that has an inner diameter matching the outer diameter of the end 141 of the second duct segment 140. The connection point 102 is a perimeter of duct located on portion 133 where the end 141 of the second duct segment 140 is contained within the portion 133 of the first duct segment 130. The disclosed duct clamp assembly is configured to be placed around the connection point 102 and to apply pressure around the connection point 102.

In FIGS. 1A and 1B, the duct segments are generally cylindrical in shape and have a substantially round or circular cross-section.

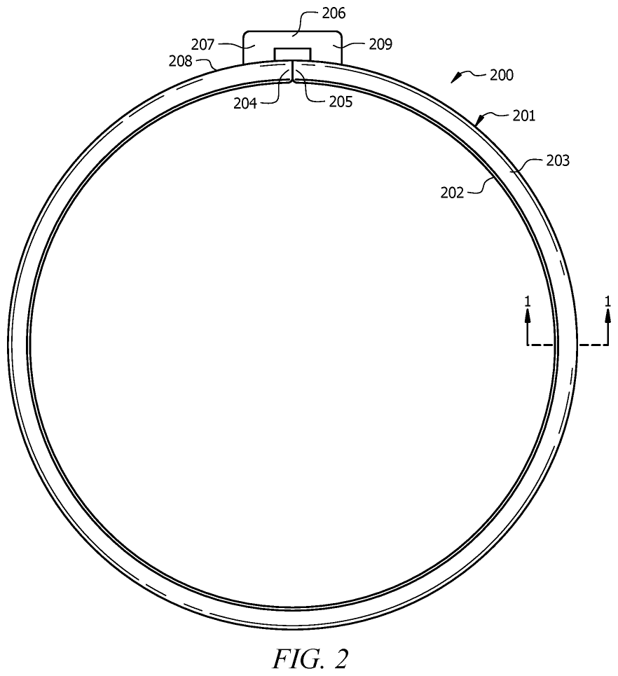

FIG. 2 illustrates a side view of an embodiment of the disclosed duct clamp assembly 200. The duct clamp assembly 200 includes a clamp 201 configured to apply pressure around a connection point of two duct segments (e.g., connection point 101 of duct segments 110 and 120 of FIG. 1A or connection point 102 of duct segments 130 and 140 of FIG. 1B), and a gasket 202 positioned on an inner surface of the clamp 201.

The clamp 201 can include a ring-shaped member 203 having a first end 204 facing and/or overlapping a second end 205. The first end 204 and second end 205 are separable so as to place the duct clamp assembly 200 around the connection point of two segments of duct, and face or align with each other when the duct clamp assembly 200 is in place around the connection point. The clamp 201 can also include a latch 206. The latch 206 can include a first portion 207 coupled to an outer surface 208 of the ring-shaped member 203 proximate the first end 204, and a second portion 209 coupled to the outer surface 208 of the ring-shaped member 203 proximate the second end 205. The first portion 207 of the latch 206 can be coupled to the outer surface 208 by being pivotally connected to the outer surface 208 of the ring-shaped member 203. The second portion 209 of the latch 206 can be coupled to the outer surface 208 by a pin or other securing mechanism for holding the second portion 209 of the latch 206 against the outer surface 208 of the ring-shaped member 203. The components of the clamp 201 can generally be made of a metal, plastic, or other suitable material. In some embodiments, the clamp 201 can be formed from any suitable metal such as aluminum, steel (e.g., a stainless steel, galvanized steel, etc.), tin, brass, or any alloy thereof.

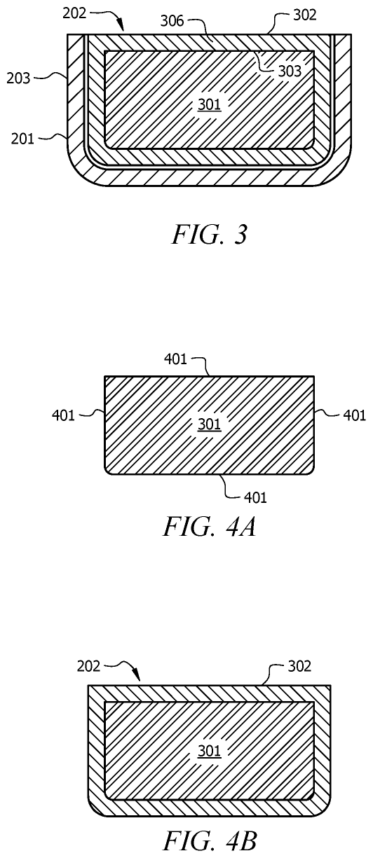

FIG. 3 illustrates a cross-section view of the ring-shaped member 203 of the clamp 201 and the gasket 202, taken along sight line 1-1 of FIG. 2. The ring-shaped member 203 generally has a U-shaped cross-section. The gasket 202 is placed in the U-shaped cross-section. The U-shaped cross-section functions to match the cross-sectional shape of the gasket 202, which in FIG. 3, is rectangular in shape. While the U-shaped cross section of the ring-shaped member 203 resembles three sides of a rectangle, and the gasket 202 has a rectangular cross-section, it is contemplated that the cross-section of the ring-shaped member 203 and gasket 202 can have other shapes and curvatures so long as the ring-shaped member 203 is configured to hold the shape of the gasket 202, and the gasket 202 has a flat top surface 306 configured to appropriately seal against the connection point of two duct segments.

The gasket 202 can include a body 301 made of foam and a layer 302 made of solid polymer. The layer 302 can contact the body 301 without being bonded or otherwise attached; alternatively, the layer 302 is attached or bonded to the body 301. In some aspects, the layer 302 can be integrally formed with the body 301.

In aspects, the gasket 202 can have thickness in a range of about 0.0625 inch to about 0.500 inch (1.5 mm to 12.7 mm) and a width in a range of about 0.25 inch to about 0.75 inch (6.3 mm to 19.1 mm).

In aspects, the foam of the body 301 can include an ethylene propylene diene monomer (EPDM) foam, a neoprene foam, a natural gum foam, a silicon foam, a nitrile foam, a urethane foam, or a combination thereof. The cross-section of the body 301 is generally the same as the cross-section of the gasket 202.

When present, the layer 302 of solid polymer can extend around an outer surface 303 of the body 301. In aspects, the layer 302 extends around the outer surface 303 of the body 301 so that all sides of the cross-section of the body 301 (e.g., all four sides of the rectangular cross-section of the body 301 shown in FIG. 3) have the layer 302 on the outer surface 303 thereof. The layer 302 of solid polymer can have a thickness that is greater than 0 mm and less than about 1 mm; alternatively, greater than 0 mm and less than about 0.5 mm; alternatively, in the range of from about 0.1 mm to about 0.5 mm. In aspects, the layer 302 has a constant thickness around the body 301. In aspects, the solid polymer can include a silicone rubber, a nitrile rubber, an ethylene propylene diene monomer (EPDM) rubber, a neoprene rubber, a polyurethane rubber, or a combination thereof.

In aspects, the solid polymer (of the layer 302) and the foam (of the body 301) are made of the same monomer units.

FIG. 4A shows a cross-sectional view of the body 301 of the gasket 202 having the layer 302 thereon, and FIG. 4B shows a cross-sectional view of the gasket 202 having the layer 302 around the body 301. In aspects, the layer 302 of the solid polymer that is around the body 301 can be derived from heating a sacrificial layer 401 of the body 301. The sacrificial layer 401 can be a part of the foam body 301 that is heated by a heating device (e.g., a hot air blower, a flame, or a hot metal surface), to form the layer 302 of solid polymer. In such aspects, the solid polymer of the layer 302 and the foam of the body 301 are made of the same monomer units, where the monomer units are polymerized into a foam for the body 301, and the sacrificial layer 401 of the foam of the body 301 is melted to form the solid polymer of the layer 302.

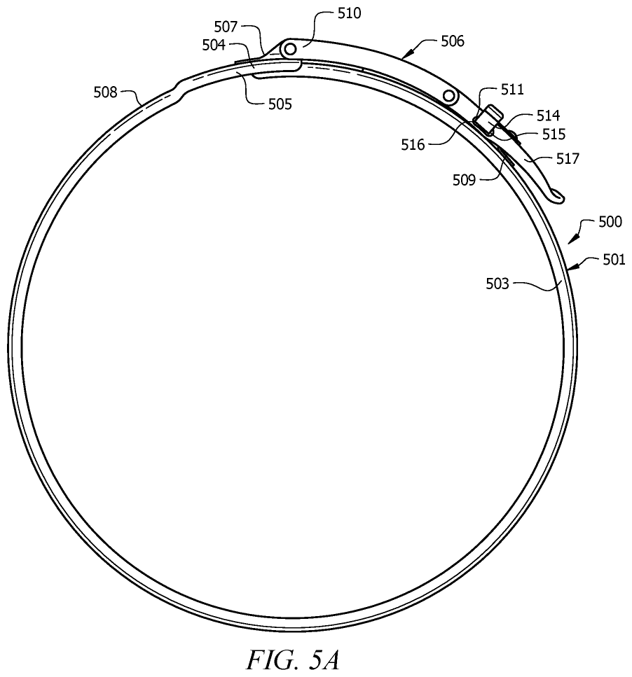

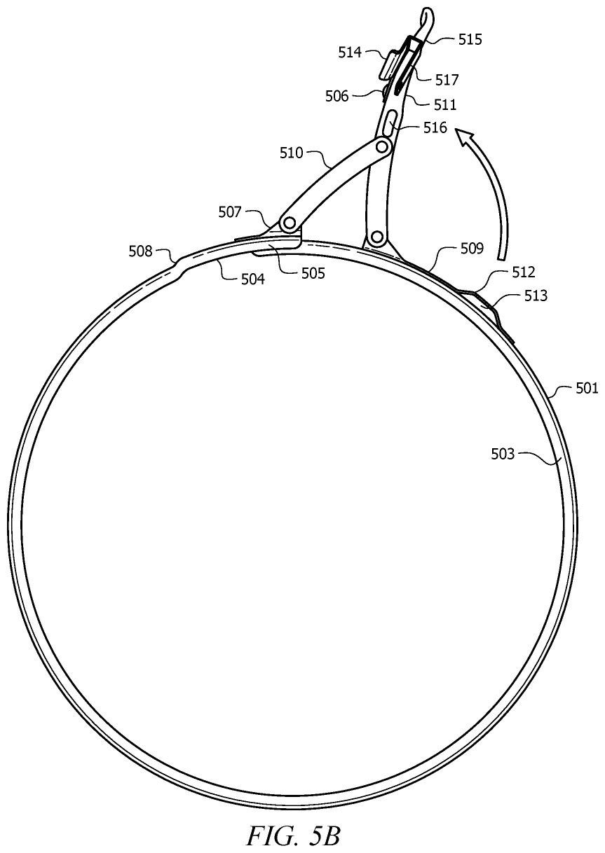

FIGS. 5A and 5B illustrate a side view of another embodiment of the disclosed duct clamp assembly 500. The duct clamp assembly 500 includes the clamp 501 and the gasket placed similarly as shown for the duct clamp assembly 200 (i.e., the gasket is not shown in FIGS. 5A and 5B, but the gasket can be any embodiment of gasket 202). FIG. 5A shows the latch 506 in a closed position, and FIG. 5B shows the latch 506 in an open position.

The clamp 501 can include a ring-shaped member 503 having a first end 504 that is placed on top of a second end 505 when the clamp 501 is in a clamping or closed position. The first end 504 and second end 505 are separable so as to place the clamp 501 around the connection point of two segments of duct, and the first end 504 fits over the second end 505 when the clamp 501 is in place around the connection point.

The clamp 501 can also include a latch 506. The latch 506 can include a first portion 507 coupled to an outer surface 508 of the ring-shaped member 503 proximate the first end 504, and a second portion 509 coupled to the outer surface 508 of the ring-shaped member 503 proximate the second end 505. The latch 506 can also include at least one bar member 510 that is pivotally connected to the first portion 507 and a handle 511 that is pivotally connected to the at least one bar member 510. The at least one bar member 510 (e.g., two bar members, one attached to each side of the first portion 507 and handle 511) provides rigidity and stiffness that allows a higher clamping pressure than if a spring bar were used in place of the at least one bar member 510. Moreover, the at least one bar member 510 can provide a more uniform and consistent pressure to the connection point of two duct segments, as compared to a spring bar, because spring bars can flex under applied pressure, whereas, the bar member 510 does not flex under the applicable pressures.

The latch 506 can also include a bridge member 512 (visible only in FIG. 5B) connected to the second portion 509. The handle 511 is configured to receive the bridge member 512 into an interior thereof when the handle 511 (and the clamp 501) is in the closed position or clamping position. The bridge member 512 is configured such that there is a space 513 between at least a portion of the bridge member 512 and the second portion 509 of the latch 506.

The latch 506 can further include a locking member 514 that is pivotally attached to the handle 511. The locking member 514 can be configured to lock the handle 511 in the closed position (also referred to as the clamping position) by pivoting a locking portion 515 through a slot 516 formed in the sides 517 of the handle 511 and into the space 513 of the bridge member 512.

The components of the clamp 201 can generally be made of a metal, plastic, or other suitable material. In some embodiments, the clamp 201 can be formed from any suitable metal such as aluminum, steel (e.g., a stainless steel, galvanized steel, etc.), tin, brass, or any alloy thereof.

It should be noted that the latch 506 of the duct clamp assembly 500 does not have ratcheted levels of clamping. That is, the duct clamp assembly 500 provides a single size for applying pressure to a connection point of two duct segments, and the clamping circumference is not adjustable. Thus, errors in clamping force or pressure introduced by clamp installers is reduced because the duct clamp assembly 500 has only one size.

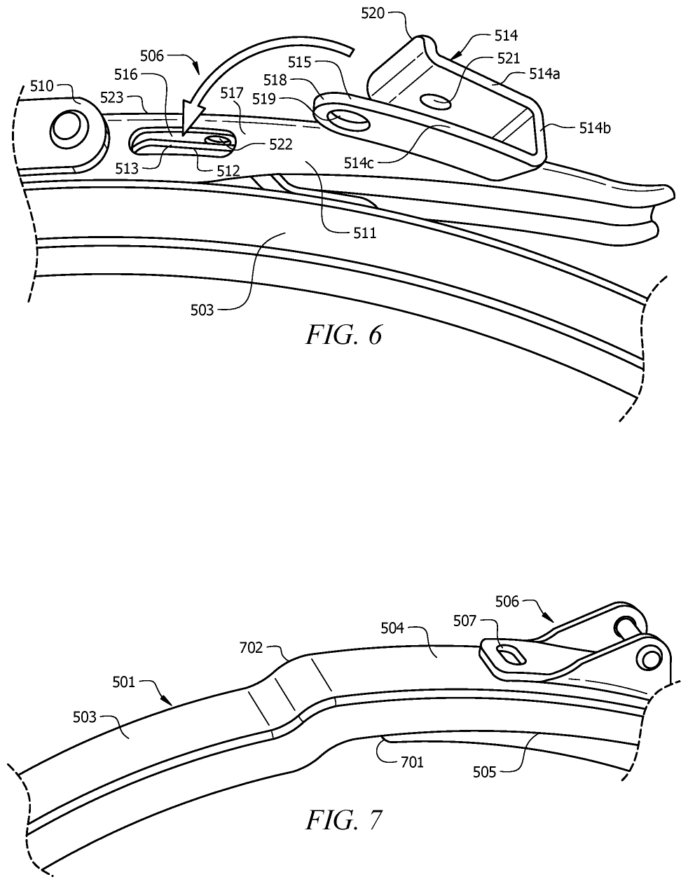

FIG. 6 illustrates a close-up perspective view of the latch 506 in FIGS. 5A and 5B. The locking member 514 can be seen in an unlocked position. The locking member 514 has a top portion 514a, wall 514b, and bottom portion 514c. The top portion 514a and the bottom portion 514c are parallel to one another, and each of the top portion 514a and the bottom portion 514c has an end connected to the wall 514b. The wall 514b can be perpendicular to the top portion 514a and bottom portion 514c. The end 518 of the bottom portion 514c that is opposite the end that is connected to the wall 514b has a hole 519 formed therein. The hole 519 is configured to receive a locking pin therein. When the locking member 514 is in the locked position, the bottom portion 514c extends through the slot 516 formed in the side 517 of the handle 511, through the space 513 of the bridge member 512, and though another slot formed on the opposite side of the handle 511 such that the end 518 of the locking member 514 extends outside the handle 511. A locking pin can be placed in the hole 519 to prevent the locking member 514 from moving to an unlocked position.

In optional aspects, the top portion 514a of the locking member 514 can have a lip 520 formed on an end opposite the end that connects to the wall 514b of the locking member 514. The lip 520 is configured to provide a surface for a human finger or hand to grab and move the locking member between the locked position and the unlocked position.

In aspects, the locking member 514 can have a protrusion 521 formed on a bottom of the top portion 514a. The protrusion 521 is sized to fit within a hole 522 formed in a top 523 of the handle 511, when the locking member 514 is in the locked position.

FIG. 7 illustrates a close-up perspective view of the first end 504 of the ring-shaped member 503 placed over the second end 505 of the ring-shaped member 503 in a position that is between the closed position and the open position. In the closed position, an end surface 701 of the second end 505 of the ring-shaped member 503 abuts against an inner surface of the raised portion 702 of the first end 504 of the ring-shaped member 503 such that a first end of the gasket (e.g., gasket 202) contacts a second end of the gasket (e.g., gasket 202).

Disclosed herein a methods for clamping and unclamping two segments of duct. One method is a method for clamping two segments of duct (e.g., duct segments 110 and 120 or duct segments 130 and 140) together. The method can include placing a duct clamp assembly 200/500 around a connection point 101/102 of the two duct segments 110 and 120/130 and 140; and compressing a gasket 202 of the duct clamp assembly 200/500 against the connection point 101/102. The gasket 202 can be of any embodiments described herein above.

In aspects, the compressing step comprises moving a latch 206/506 of the duct clamp assembly 200/500 from an open position to a closed position. In aspects, when the latch 506 is in the closed position, the method can also include pivoting the locking member 514 of the latch 506 into the slot 516 of the latch 506 and then into the bridge member 512 of the latch 506. The bridge member 512 can be located under a handle 511 of the latch 506 when the duct clamp assembly 500 is in the closed position.

Another method is a method for maintaining a connection point 101/102 of two segments of duct (e.g., duct segments 110 and 120 or duct segments 130 and 140) held together by a duct clamp assembly 500 disclosed herein. The method can include pivoting the locking member 514 of the latch 506 out of the bridge member 512 of the latch 506 and then out of a slot 516 of the latch 506; and removing a compression force from the gasket 202. The gasket 202 can be of any embodiments described herein above. In aspects, the removing step comprises moving the latch 506 from a closed position to an open position.

The duct clamp assemblies 200 and 500 disclosed herein are useful for any type of duct, including but not limited to, plasma and laser ducts.

In aspects, the method further includes re-applying the compressing force to the gasket 202 such that the gasket 202 is again compressed between the clamp 501 and the connection point 101/102. In aspects, the re-applying step comprises moving the latch 506 from an open position to a closed position; and pivoting the locking member 514 into the slot 516 of the latch 506 and then into the bridge member 512, wherein the bridge member 512 is located under the handle 511 when the latch 506 is in the closed position.

Having described various configurations, devices, and methods, certain aspects can include, but are not limited to:

In a first aspect, a duct clamp assembly comprises a clamp configured to apply pressure around a connection point of two duct segments; and a gasket positioned on an inner surface of the clamp, wherein the gasket comprises a body made of a foam and a layer made of a solid polymer, wherein the layer extends around an outer surface of the body.

A second aspect can include the duct clamp assembly of the first aspect, wherein the layer of the solid polymer has a thickness that is greater than 0 mm and less than about 1 mm.

A third aspect can include the duct clamp assembly of the first or second aspect, wherein the solid polymer comprises a silicone rubber, a nitrile rubber, an ethylene propylene diene monomer (EPDM) rubber, a neoprene rubber, a polyurethane rubber, or a combination thereof; and wherein the foam comprises an EPDM foam, a neoprene foam, a natural gum foam, a silicon foam, a nitrile foam, a urethane foam, or a combination thereof.

A fourth aspect can include the duct clamp assembly of the third aspect, wherein the solid polymer and the foam are made of the same monomer units; or wherein the layer of the solid polymer is derived from heating a sacrificial layer of the body.

A fifth aspect can include the duct clamp assembly of any one of the first to fourth aspects, wherein the gasket has a rectangular cross section.

A sixth aspect can include the duct clamp assembly of the fifth aspect, wherein the gasket has thickness in a range of about 0.0625 inch to about 0.500 inch (1.5 mm to 12.7 mm) and a width in a range of about 0.25 inch to about 0.75 inch (6.3 mm to 19.1 mm).

A seventh aspect can include the duct clamp assembly of any one of the first to sixth aspects, wherein the clamp comprises: a ring-shaped member having a first end facing a second end; and a latch comprising a first portion coupled to an outer surface of the ring-shaped member proximate the first end and a second portion coupled to the outer surface of the ring-shaped member proximate the second end.

An eighth aspect can include the duct clamp assembly of the seventh aspect, wherein the latch further comprises: at least one bar member that is pivotally connected to the first portion; and a handle pivotally connected to the at least one bar member.

A ninth aspect can include the duct clamp assembly of the eighth aspect, wherein the latch further comprises a bridge member connected to the second portion of the latch, wherein the handle is configured to receive the bridge member into an under side of the handle.

A tenth aspect can include the duct clamp assembly of the ninth aspect, wherein the latch further comprises a locking member pivotally attached to the handle and configured to lock the handle in a closed position by pivoting a locking portion through a slot formed in a side of the handle and into the bridge member.

An eleventh aspect can include the duct clamp assembly of any one of the seventh to tenth aspects, wherein the ring-shaped member has a U-shaped cross section and the gasket is placed in the U-shaped cross-section.

In a twelfth aspect, a method for clamping two segments of duct together comprises: placing a duct clamp assembly around a connection point of the two segments of duct; and compressing a gasket of the duct clamp assembly against the connection point, wherein the gasket comprises a body made of a foam and a layer made of a solid polymer, wherein the layer extends around an outer surface of the body.

A thirteenth aspect can include the method of the twelfth aspect, wherein the compressing step comprises moving a latch of the duct clamp assembly from an open position to a closed position, the method further comprising: when the latch is in the closed position, pivoting a locking member of the latch into a slot of the latch and then into a bridge member of the latch, wherein the bridge member is located under a handle of the latch when the duct clamp assembly is in the closed position.

A fourteenth aspect can include the method of the twelfth or thirteenth aspect, wherein the layer of the solid polymer has a thickness that is greater than 0 mm and less than about 1 mm.

A fifteenth aspect can include the method of any one of the twelfth to fourteenth aspects, wherein the gasket has a rectangular cross section, a thickness in a range of about 0.0625 inch to about 0.500 inch (1.5 mm to 12.7 mm), and a width in a range of about 0.25 inch to about 0.75 inch (6.3 mm to 19.1 mm).

In a sixteenth aspect, a method for maintaining a connection point of two segments of duct held together by a duct clamp assembly comprising a clamp and a gasket compressed between the clamp and the connection point comprises: pivoting a locking member of a latch of the clamp out of a bridge member of the latch and then out of a slot of the latch; and removing a compression force from the gasket, wherein the gasket comprises a body made of a foam and a layer made of a solid polymer, wherein the layer extends around an outer surface of the body.

A seventeenth aspect can include the method of the sixteenth aspect, wherein the removing step comprises moving the latch from a closed position to an open position.

An eighteenth aspect can include the method of the sixteenth or seventeenth aspect, further comprising: re-applying the compressing force to the gasket such that the gasket is again compressed between the clamp and the connection point.

A nineteenth aspect can include the method of the eighteenth aspect, wherein the re-applying step comprises: moving the latch from an open position to a closed position; and pivoting the locking member into the slot of the latch and then into the bridge member of the latch, wherein the bridge member is located under a handle of the latch when the latch is in the closed position.

A twentieth aspect can include the method of any one of the sixteenth to nineteenth aspect, wherein the layer of the solid polymer has a thickness that is greater than 0 mm and less than about 1 mm.

While various embodiments have been shown and described, modifications thereof can be made by one skilled in the art without departing from the spirit and teachings of the disclosure. The embodiments described herein are exemplary only, and are not intended to be limiting. Many variations and modifications of the subject matter disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L} and an upper limit, R_{U} is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

The following brief definition of terms shall apply throughout the application. The term “comprising” means including but not limited to, and should be interpreted in the manner it is typically used in the patent context. The phrases “in one embodiment,” “according to one embodiment,” “in some embodiments,” and the like generally mean that the particular feature, structure, or characteristic following the phrase may be included in at least one embodiment of the present invention, and may be included in more than one embodiment of the present invention (importantly, such phrases do not necessarily refer to the same embodiment). If the specification describes something as “exemplary” or an “example,” it should be understood that refers to a non-exclusive example. The terms “about” or “approximately” or the like, when used with a number, may mean that specific number, or alternatively, a range in proximity to the specific number, as understood by persons of skill in the art field. If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

While several embodiments have been provided in the present disclosure, it should be understood that the disclosed systems and methods may be embodied in many other specific forms without departing from the spirit or scope of the present disclosure. The embodiments and present examples are to be considered as illustrative and not restrictive, and the intention is not to be limited to the details given herein. Many variations and modifications of the invention disclosed herein are possible and are within the scope of the invention. For example, the various elements or components may be combined or integrated in another system or certain features may be omitted or not implemented. Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

Numerous other modifications, equivalents, and alternatives, will become apparent to those skilled in the art once the above disclosure is fully appreciated. It is intended that the following claims be interpreted to embrace all such modifications, equivalents, and alternatives where applicable. Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

What is claimed is:

1. A duct clamp assembly comprising:
a clamp configured to apply pressure around a connection point of two duct segments; and
a gasket positioned on an inner surface of the clamp, wherein the gasket comprises a body made of a foam and a layer made of a solid polymer, wherein the layer extends around an outer surface of the body.

2. The duct clamp assembly of claim 1, wherein the layer of the solid polymer has a thickness that is greater than 0 mm and less than about 1 mm.

3. The duct clamp assembly of claim 1, wherein the solid polymer comprises a silicone rubber, a nitrile rubber, an ethylene propylene diene monomer (EPDM) rubber, a neoprene rubber, a polyurethane rubber, or a combination thereof; and wherein the foam comprises an EPDM foam, a neoprene foam, a natural gum foam, a silicon foam, a nitrile foam, a urethane foam, or a combination thereof.

4. The duct clamp assembly of claim 3, wherein the solid polymer and the foam are made of the same monomer units; or wherein the layer of the solid polymer is derived from heating a sacrificial layer of the body.

5. The duct clamp assembly of claim 1, wherein the gasket has a rectangular cross section.

6. The duct clamp assembly of claim 5, wherein the gasket has thickness in a range of about 0.0625 inch to about 0.500 inch (1.5 mm to 12.7 mm) and a width in a range of about 0.25 inch to about 0.75 inch (6.3 mm to 19.1 mm).

7. The duct clamp assembly of claim 1, wherein the clamp comprises:
a ring-shaped member having a first end facing a second end; and
a latch comprising a first portion coupled to an outer surface of the ring-shaped member proximate the first end and a second portion coupled to the outer surface of the ring-shaped member proximate the second end.

8. The duct clamp assembly of claim 7, wherein the latch further comprises:
at least one bar member that is pivotally connected to the first portion; and
a handle pivotally connected to the at least one bar member.

9. The duct clamp assembly of claim 8, wherein the latch further comprises a bridge member connected to the second portion of the latch, wherein the handle is configured to receive the bridge member into an under side of the handle.

10. The duct clamp assembly of claim 9, wherein the latch further comprises a locking member pivotally attached to the handle and configured to lock the handle in a closed position by pivoting a locking portion through a slot formed in a side of the handle and into the bridge member.

11. The duct clamp assembly of claim 7, wherein the ring-shaped member has a U-shaped cross section and the gasket is placed in the U-shaped cross-section.

12. A method for clamping two segments of duct together, the method comprising:
placing a duct clamp assembly around a connection point of the two segments of duct; and
compressing a gasket of the duct clamp assembly against the connection point, wherein the gasket comprises a body made of a foam and a layer made of a solid polymer, wherein the layer extends around an outer surface of the body.

13. The method of claim 12, wherein the compressing step comprises moving a latch of the duct clamp assembly from an open position to a closed position, the method further comprising:
when the latch is in the closed position, pivoting a locking member of the latch into a slot of the latch and then into a bridge member of the latch, wherein the bridge member is located under a handle of the latch when the duct clamp assembly is in the closed position.

14. The method of claim 12, wherein the layer of the solid polymer has a thickness that is greater than 0 mm and less than about 1 mm.

15. The method of claim 12, wherein the gasket has a rectangular cross section, a thickness in a range of about 0.0625 inch to about 0.500 inch (1.5 mm to 12.7 mm), and a width in a range of about 0.25 inch to about 0.75 inch (6.3 mm to 19.1 mm).

16. A method for maintaining a connection point of two segments of duct held together by a duct clamp assembly comprising a clamp and a gasket compressed between the clamp and the connection point, the method comprising:
pivoting a locking member of a latch of the clamp out of a bridge member of the latch and then out of a slot of the latch; and
removing a compression force from the gasket, wherein the gasket comprises a body made of a foam and a layer made of a solid polymer, wherein the layer extends around an outer surface of the body.

17. The method of claim 16, wherein the removing step comprises moving the latch from a closed position to an open position.

18. The method of claim 16, further comprising:
re-applying the compressing force to the gasket such that the gasket is again compressed between the clamp and the connection point.

19. The method of claim 18, wherein the re-applying step comprises:
moving the latch from an open position to a closed position; and
pivoting the locking member into the slot of the latch and then into the bridge member of the latch, wherein the bridge member is located under a handle of the latch when the latch is in the closed position.

20. The method of claim 16, wherein the layer of the solid polymer has a thickness that is greater than 0 mm and less than about 1 mm.
